(19) United States
(12) Patent Application Publication
(10) Pub. No.: US 2014/0237137 A1
(43) Pub. Date: Aug. 21, 2014

(54) SYSTEM FOR DISTRIBUTING FLOW TO DISTRIBUTED SERVICE NODES USING A UNIFIED APPLICATION IDENTIFIER

(71) Applicant: CISCO TECHNOLOGY, INC., San Jose, CA (US)

(72) Inventors: Jimmy Ervin, Raleign, NC (US); Mani Ramasamy, San Jose, CA (US); Scott Alexander, Palm Harbor, FL (US); Steven Rempe, Efland, NC (US); Venkataraman Anand, San Ramon, CA (US)

(73) Assignee: CISCO TECHNOLOGY, INC., San Jose, CA (US)

(21) Appl. No.: 13/769,525

(22) Filed: Feb. 18, 2013

(51) Int. Cl. H04L 12/56

(52) U.S. Cl. CPC H04L 45/38
USPC 709/238

(57) ABSTRACT

In one embodiment, a method includes obtaining a flow, identifying an application associated with the flow, and identifying a first unique application identifier (UAID) for the application. The first UAID uniquely identifies the application. The method also includes adding the first UAID to the flow, and routing the flow through a network after adding the first UAID to the flow.

### TECHNICAL FIELD

The disclosure relates generally to computing and virtualization. More particularly, the disclosure relates to allowing a flow navigator in a network that utilizes dynamic port assignments to direct a flow to a service using a known application identifier.

### BACKGROUND

Increased visibility and control of applications running on a network is generally desired by customers such that the flow of data may be accurately and efficiently controlled. For example, when servers within a network are migrated from a branch office to a data center or to a cloud provider, in order to effectively provide control between a client and a server, the ability to identify applications associated with data that flows within the network is generally needed. Services within a network, e.g., a wide area network (WAN) service or a firewall, typically need to identify an application associated with a data flow in order to control the data flow between an appropriate client and an appropriate server.

Many applications utilize dynamic port assignments within Transmission Control Protocol (TCP) and Universal Datagram Protocol (UDP). As will be appreciated by those skilled in the art, a connection is generally made between a client and a server in TCP such that data may be sent along the connection, while UDP allows data to be sent in packets across a network without maintaining a connection. In addition to utilizing dynamic port assignments, applications may be overlapped on the same port within TCP. As ports are often used to identify an application associated with a data flow, the dynamic assignment of ports and the use of the same port from more than one application often renders identifying the application associated with a data flow may be difficult.

### BRIEF DESCRIPTION OF THE DRAWINGS

The disclosure will be readily understood by the following detailed description in conjunction with the accompanying drawings in which:

FIG. 1 is a block diagram representation of a network in which a universal application identifier (UAID) is used to allow a flow associated with the UAID to be properly identified in accordance with an embodiment.

FIG. 2 is a block diagram representation of a network in which a flow navigator is embodied as a wide area application services (WAAS) module in accordance with an embodiment.

FIG. 3 is a diagrammatic representation of a process in which a flow associated with an application is obtained by a node, and a unique application identifier is assigned to the application, in accordance with an embodiment.

FIG. 4 is a process flow diagram which illustrates a method of providing a port number and a UAID associated with a flow in accordance with an embodiment.

FIG. 5 is a block diagram representation of a node that is configured to allow applications running in a network to be identified in accordance with an embodiment.

### DESCRIPTION OF EXAMPLE EMBODIMENTS

### General Overview

According to one aspect, a method includes obtaining a flow, identifying an application associated with the flow, and identifying a first unique application identifier (UAID) for the application. The first UAID uniquely identifies the application. The method also includes adding the first UAID to the flow, and routing the flow through a network after adding the first UAID to the flow. In one embodiment, adding the first UAID to the flow includes replacing a second UAID in the flow with the first UAID.

### Description

The ability for services within a network to be able to readily identify an application associated with a data flow between a client and a server of the network allows the data flow to be controlled in an efficient manner. In one embodiment, when a flow navigator or a router obtains a data flow, the flow navigator or router may identify an application associated with the data flow, and add a unified application identifier (UAID) that identifies the application to the data flow. Services that obtain a data flow which includes a UAID may use the UAID to identify an application running within a network.

By providing a UAID, which is understood by substantially every service associated with a domain, in a data flow, any service that obtains the data flow may be able to use the UAID to identify an application associated with the data flow. That is, as each application associated with a domain may be assigned a unique UAID which may be recognized by, e.g., is known to, substantially all services within the domain, a UAID contained in the data flow may be used to identify an application associated with the data flow. In lieu of utilizing a Transmission Control Protocol (TCP) port number or a Universal Datagram Protocol (UDP) port number in an effort to identify an application, a UAID which is unique to the application may be used to efficiently identify an application associated with a data flow, even when a port number is dynamically assigned and/or more than one application is overlapped on the same port.

Allowing services, e.g., a local agent, to identify applications running on a domain and to distribute information which identifies the applications on a flow routed to other services facilitates the ability of the other services to identify data flows associated with the applications. A service that receives or otherwise obtains a data flow which contains a UAID may look at the UAID rather than a port number, and also cause the UAID to be updated to essentially report a more specific classification. That is, a UAID already contained in a data flow may generally classify an application, and updating the UAID may more specifically classify the application. For example, a UAID embedded in a data flow may be in a Hypertext Transfer Protocol (http) format, and a service may report an update to a flow navigator that effectively changes the UAID to a Simple Object Access Protocol (SOAP) format.

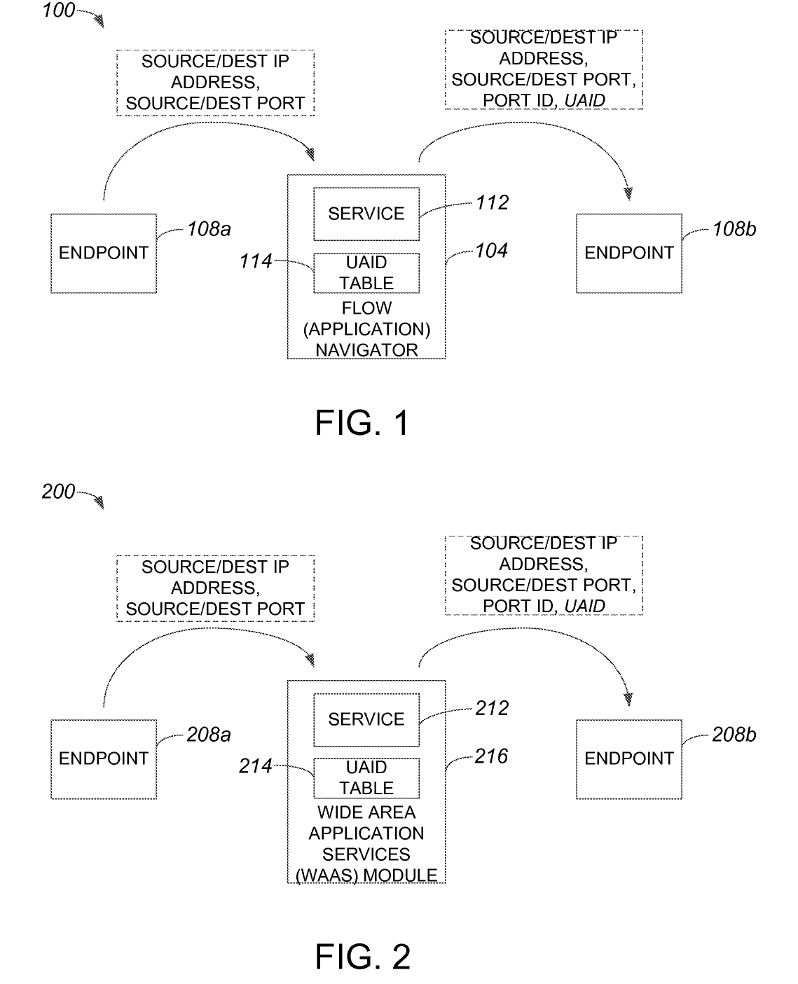

Referring initially to FIG. 1, a network in which a UAID may be used to allow a flow associated with the UAID to be properly identified will be described in accordance with an embodiment. A network 100 includes endpoints 108a, 108b, as well as a node 104, which may be a flow navigator or an application navigator. A data flow intended to be sent or passed from endpoint 108a, e.g., a client, to endpoint 108b, e.g., a server, may pass through node 104. Node 104, which may be a flow or application navigator, may intercept the data flow.

The data flow that is intercepted by node 104 may generally include a source and/or destination address, e.g., an Internet protocol (IP) address, as well as a source and/or destination port. When the data flow is intercepted by node 104, a service 112 on node 104 may identify an application associated with the data flow, and index into a table 114, e.g., a UAID table, that includes information that correlates applications to UAIDs. Table 114 includes UAIDs or, more generally, unique application identifiers which are substantially universally known within network 100. Once service 112 identifies a unique application identifier corresponding to an application with which the data flow is associated, service 112 embeds the unique application identifier into the data flow, and forwards the data flow to endpoint 108b.

Generally, a node such as node 104 of FIG. 1 on which a service which embeds a unique application identifier in a data flow, as for example as metadata, may generally be any suitable network element. As previously mentioned, a node may be a flow navigator or an application navigator. In one embodiment, a node may be a wide area application services (WAAS) module available commercially from Cisco Systems, Inc. of San Jose, California. A WAAS module is a cloud-ready Wide Area Network (WAN) optimization and acceleration arrangement that provides application acceleration substantially on-demand.

FIG. 2 is a block diagram representation of a network in which a node that is capable of embedding a unique application identifier in a data flow is embodied as a WAAS module in accordance with an embodiment. A network 200 includes endpoints 208a, 208b, as well as a WAAS module 216. A data flow intended to be sent or passed from endpoint 208a to endpoint 208b, e.g., a server, may be intercepted by WAAS module 216 as the data flow passes through WAAS module 216.

The data flow that is intercepted by WAAS module 216 may include a source and/or destination address, as well as information relating to a source and/or destination port. When WAAS module 216 intercepts or otherwise obtains the data flow, a service 212 on WAAS module 216 may identify an application associated with the data flow, and effectively search a table 214, e.g., a UAID table, that includes information relating to applications and their associated UAIDs. Table 214 generally includes UAIDs that are substantially universally known within network 200. When service 212 identifies a UAID corresponding to an application with which the data flow is associated, service 212 embeds the unique application identifier into the data flow, and forwards the data flow to endpoint 208b.

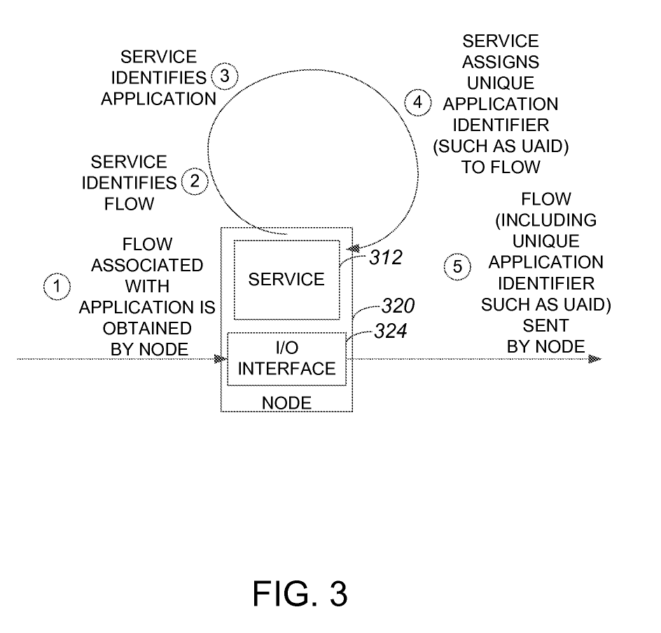

FIG. 3 is a diagrammatic representation of a process in which a data flow associated with an application is obtained by a node and a unique application identifier is assigned to the application, in accordance with an embodiment. A node 320, e.g., a network element on which a service 312 that may assign a unique application identifier to an application resides, obtains a data flow associated with an application. The data flow generally includes data packets which contain information relating to the application, as well as metadata associated with the data packets. The data flow may be obtained by an input/output (I/O) interface 324 of node 320.

Service 312 identifies the data flow, and also identifies the application with which the data flow is associated. Upon identifying the application, the service assigns a unique application identifier, e.g., a UAID, to the data flow to identify the data flow as being associated with the application. Assigning the unique application identifier to the data flow generally includes embedding the unique application identifier as metadata in the data flow. I/O interface 324 may forward, or otherwise provide, the data flow, which includes the unique application identifier embedded therein, through a network.

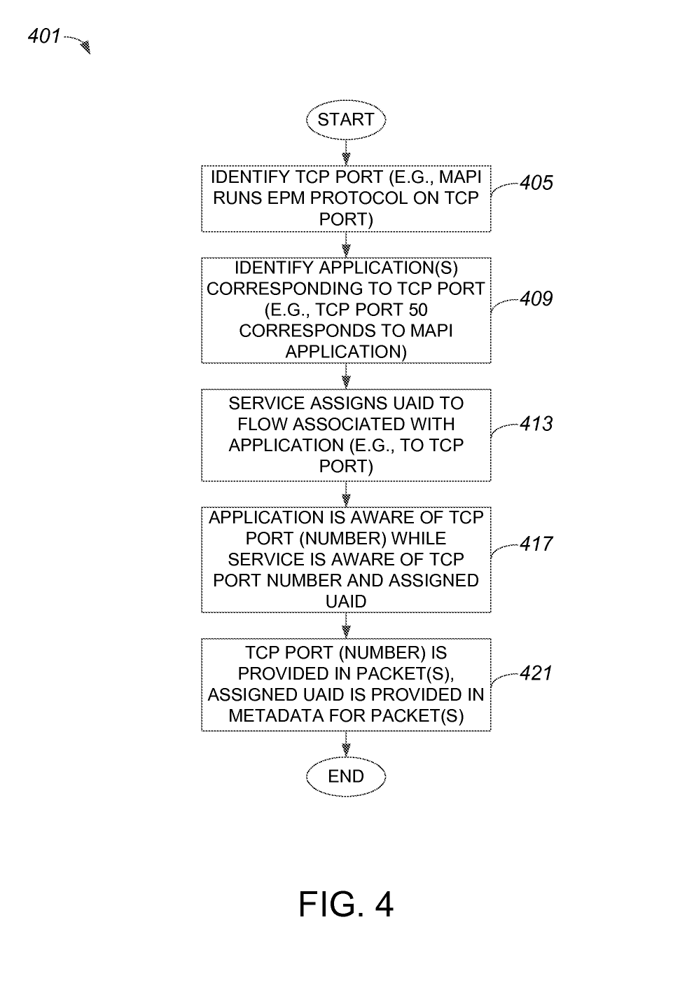

With reference to FIG. 4, a method of providing a port number and a unique application identifier such as a UAID associated with a data flow will be described in accordance with an embodiment. A method 401 of providing a port number and a unique application identifier such as a UAID begins at step 405 in which a port, e.g., a TCP port, that handles a data flow for an application is identified. The port may be identified, in one embodiment, by a node within a network that supports services. Such a node may generally be a local agent or a flow navigator. Identifying a port such as a TCP port may involve, for a MAPI flow, causing an endpoint mapper (EPM) protocol to effectively run on TCP ports to identify an appropriate TCP port.

Once a port is identified, an application that corresponds to the port may be identified in step 409. As will be appreciated by those skilled in the art, some applications are typically assigned to particular ports. By way of example, TCP Port 50 typically corresponds to a MAPI application. In step 413, a service assigns a unique application identifier to the flow associated with the application that is effectively known throughout the network. When a particular TCP port typically corresponds to a particular application, assigning the unique application identifier to the particular application may also be considered to effectively assign the unique application identifier to the TCP port.

After the service assigns a unique application identifier to the flow associated with an application, the application is effectively aware in step 417 of a port number to which the application is assigned, while the service is aware of both the port number and an assigned unique application identifier. In other words, the service has information regarding both a port number and a unique application identifier, e.g., a UAID, which correspond to an application. By way of example, for a MAPI application, the MAPI application may be aware that TCP port 50 is associated with the MAPI application, while a service is aware that TCP port 50 and a unique application identifier are associated with the MAPI application.

From step 417, process flow proceeds to step 421 in which a port number may be provided in packets of a data flow, while an assigned unique application identifier is provided in metadata associated with the packets in the data flow. For example, the unique application identifier may be in metadata that is in packets. In one embodiment, a node embeds an assigned unique application identifier into a data flow for an application identified by the assigned unique application identifier, then effectively forwards the data flow towards a destination. Once an assigned unique application identifier is embedded in a data flow, the method of providing a port number and a unique application identifier is completed.

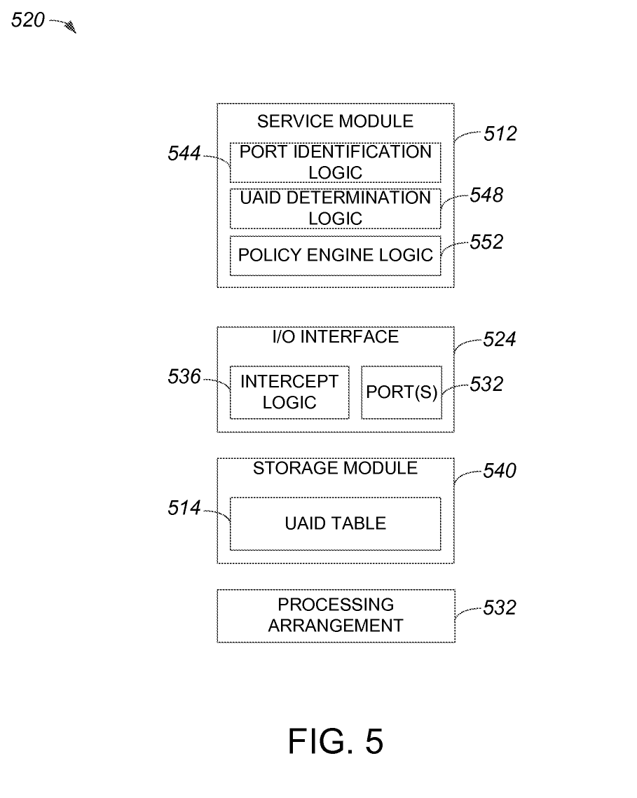

FIG. 5 is a block diagram representation of a node, as for example a centralized flow navigator or a router, in accordance with an embodiment. A node 520, which may generally be an element included in a domain or a network, includes a service module 512, an I/O interface 526, a storage module 540, and a processing arrangement 532. Node 520 may intercept traffic originating from one endpoint associated with a network and intended for another endpoint associated with the network.

Service module 512, which may generally include hardware and/or software logic, includes port identification logic 544, UAID determination logic 548, and policy engine logic 552. Port identification logic 544 is configured to assign or otherwise identify a port associated with a data flow, and may cause an identifier for the data flow to be included, e.g., embedded, in the data flow. In general, port identification logic 544 may identify a TCP port number or a UDP port number. UAID determination logic 548 identifies a unique application identifier, e.g., a UAID, for an application with which a data flow is associated, and may embed the unique application identifier into the data flow, as for example as metadata. UAID determination logic 548 may identify a unique application identifier, in one embodiment, by effectively searching a table 514 that lists substantially all application identifiers associated with a domain. That is, UAID determination logic 548 may perform a lookup in table 514 to identify a unique application identifier for an application. It should be appreciated that a unique application identifier is not limited to being identified in a table 514, and may typically be identified or otherwise determined using any suitable method. In one embodiment, table 514 includes information that effectively maps UAIDs to ports, e.g., TCP ports or UDP ports.

UAID determination logic 548 may also obtain an application identifier embedded in an obtained data flow, and identify the application with which the data flow is associated. In one embodiment, UAID determination logic 548 may effectively update the application identifier embedded in the obtained data flow with another application identifier, e.g., an application identifier that effectively reports a more specific classification of the application.

Policy engine logic 552 is configured to construct policies that may be used to examine an application identifier for an application. Such policies may be used to select services to substantially insert between endpoints associated with a domain, and may allow for a dynamic flow-based insertion of services based on an application identifier such as a UAID.

I/O interface logic 524 is configured to allow flow navigator 520 to obtain information from a network and to provide information on the network. I/O interface 524 typically includes at least one port 532, as well as intercept logic 536 arranged to allow a data flow to be obtained, e.g., intercepted. Storage module 540 may be a database that is arranged to store applications in UAID table 514. In one embodiment, UAID table 514 may include mappings between application identifiers and port numbers.

Processing arrangement 532 generally includes at least one processor, or processing unit. As will be appreciated by those skilled in the art, processing arrangement 532 is configured to cause software logic to execute. By way of example, processing arrangement 532 may execute UAID determination logic 548 to effectively cause an application identifier to be identified or otherwise determined.

Although only a few embodiments have been described in this disclosure, it should be understood that the disclosure may be embodied in many other specific forms without departing from the spirit or the scope of the present disclosure. By way of example, a unique application identifier such as a UAID may be embedded in a data flow by substantially any node or element within a network. In one embodiment, a unique application identifier may be embedded in a data flow when the data flow is created or otherwise initiated.

In one embodiment, a single service may report information such as a UAID substantially in real-time to a centralized node, e.g., a centralized flow navigator or router. The information may be reported or otherwise distributed to other services by a single service upon the establishment of a new flow or an update to an existing flow.

As described above, a unique application identifier such as a UAID may be embedded in metadata of a flow. For example, a UAID may be appended to a connection setup frame such as a TCP SYN frame within a flow.

Traffic flows for substantially any type of service may generally be updated to include a unique application identifier such as a UAID. Traffic flows may be for services that include, but are not limited to including, firewalls, wide area network (WAN) acceleration, and/or cloud based service redirection.

The embodiments may be implemented as hardware and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining a flow;
identifying an application associated with the flow;
identifying a first unique application identifier (UAID) for the application, wherein the first UAID uniquely identifies the application;
adding the first UAID to the flow; and
routing the flow through a network after adding the first UAID to the flow.

2. The method of claim 1 wherein the flow includes an indicator that identifies a destination port, and wherein identifying the first UAID for the application includes determining if the destination port is included in a mapping database and obtaining the first UAID from the mapping database based on the destination port.

3. The method of claim 2 wherein obtaining the flow includes identifying the flow as a new flow before obtaining the first UAID from the mapping database based on the destination port.

4. The method of claim 1 wherein the flow includes packets and metadata, and wherein adding the first UAID to the flow includes adding the first UAID to the metadata.

5. The method of claim 1 wherein adding the first UAID to the flow includes replacing a second UAID in the flow, the second UAID being arranged to identify the application, and wherein the first UAID is a specific classification of the application and the second UAID is a general classification of the application.

6. The method of claim 5 wherein the second UAID identifies Hypertext Transfer Protocol (http) format and the first UAID identifies Simple Object Access Protocol (SOAP).

7. A tangible, non-transitory computer-readable medium comprising computer program code, the computer program code, when executed, configured to:
obtain a flow;
identify an application associated with the flow;
identify a first unique application identifier (UAID) for the application, wherein the first UAID uniquely identifies the application;
add the first UAID to the flow; and
route the flow through a network after adding the first UAID to the flow.

8. The tangible, non-transitory computer-readable medium comprising computer program code of claim 7 wherein the flow includes an indicator that identifies a destination port, and wherein the computer program code configured to identify the first UAID for the application is further configured to determine if the destination port is included in a mapping database and obtaining the first UAID from the mapping database based on the destination port.

9. The tangible, non-transitory computer-readable medium comprising computer program code of claim 8 wherein the computer program code configured to obtain the flow includes is further configured to identify the flow as a new flow before obtaining the first UAID from the mapping database based on the destination port.

10. The tangible, non-transitory computer-readable medium comprising computer program code of claim 7 wherein the flow includes packets and metadata, and wherein the computer program code configured to add the first UAID to the flow includes computer program code configured to add the first UAID to the metadata.

11. The tangible, non-transitory computer-readable medium comprising computer program code of claim 7 wherein the computer program code configured to add the first UAID to the flow is further configured to replace a second UAID in the flow, the second UAID being arranged to identify the application, and wherein the first UAID is a specific classification of the application and the second UAID is a general classification of the application.

12. The tangible, non-transitory computer-readable medium comprising computer program code of claim 11 wherein the second UAID identifies Hypertext Transfer Protocol (http) format and the first UAID identifies Simple Object Access Protocol (SOAP).

13. An apparatus comprising:
means for obtaining a flow;
means for identifying an application associated with the flow;
means for identifying a first unique application identifier (UAID) for the application, wherein the first UAID uniquely identifies the application;
means for adding the first UAID to the flow; and
means for routing the flow through a network after adding the first UAID to the flow.

14. An apparatus comprising:
an input/output (I/O) interface, wherein the I/O interface is configured to intercept a flow; and
a service module, the service module being configured to identify an application with which the flow is associated, the service module further being configured to identify a first unique application identifier that identifies the application and to embed the first unique application identifier in the flow, wherein the service module is still further arranged to cause the flow to be provided to a network through the I/O interface after the first unique application identifier is embedded in the flow.

15. The apparatus of claim 14 wherein the apparatus is a centralized flow navigator.

16. The apparatus of claim 14 further including:
a storage module, the storage module being configured to store a table, wherein the service module performs a lookup in a table to identify the first unique application identifier, the first unique application being recognized throughout the network.

17. The apparatus of claim 14 wherein the service module is further configured to identify a second unique application identifier that identifies the application, the second unique application identifier being contained in the flow, wherein the service module is configured to embed the first unique application identifier in the flow such that the first unique application identifier replaces the second unique application identifier.

18. The apparatus of claim 17 wherein the service module includes a policy engine, the policy engine being configured to construct at least one policy which is used to examine the second application identifier.

19. The apparatus of claim 14 wherein the service module is configured to embed the first unique application identifier in metadata contained in the flow.
